(19) United States
(12) Patent Application Publication
(10) Pub. No.: US 2025/0023406 A1
(43) Pub. Date: Jan. 16, 2025

(54) ROTOR OF ROTATING ELECTRIC MACHINE

(71) Applicant: Hitachi Astemo, Ltd., Hitachinaka-shi, Ibaraki (JP)

(72) Inventors: Yukihiro YOSHINARI, Hitachinaka-shi, Ibaraki (JP); Noriaki HINO, Hitachinaka-shi, Ibaraki (JP); Takuya MIYAGI, Hitachinaka-shi, Ibaraki (JP)

(73) Assignee: Hitachi Astemo, Ltd., Hitachinaka-shi, Ibaraki (JP)

(21) Appl. No.: 18/710,078

(22) PCT Filed: Nov. 16, 2021
(86) PCT No.: PCT/JP2021/042124

§ 371 Date: May 14, 2024

(51) Int. Cl. H02K 1/276; H02K 29/03

(52) U.S. Cl. CPC H02K 1/276; H02K 29/03

(57) ABSTRACT

A rotor of a rotating electric machine includes a pair of magnets arranged in a V shape and a rotor core provided with magnet holes into which the magnets are inserted. The rotor core has, on an outside in a radial direction, a magnetic gap between the rotor core and an outermost diameter corner located on an outermost side in the radial direction among corners of the magnet, and has a protrusion formed so as to protrude toward the magnet between a first outermost diameter portion closer to a magnetic pole center of the rotor than the outermost diameter corner in an outer diameter of the magnetic gap and a second outermost diameter portion closer to a magnetic pole boundary of the rotor than the outermost diameter corner in an outermost diameter of the magnetic gap, and the protrusion faces a main surface of the magnet.

### TECHNICAL FIELD

The present invention relates to a rotor of a rotating electric machine.

### BACKGROUND ART

As a background art of the invention of the present application, for example, PTL 1 below discloses a configuration in which a plurality of holes for positioning a magnet are formed, and a flux barrier, a side bridge, and a first recess and a second recess that are recessed inward of a rotor core from both ends in a circumferential direction of the side bridge are provided, thereby improving durability while maintaining good characteristics as an electric motor.

### CITATION LIST

### Patent Literature

PTL 1: JP 2014-197971 A

### SUMMARY OF INVENTION

### Technical Problem

In the above configuration, it is not possible to achieve both an increase in maximum torque and a reduction in stress. In view of this, an object of the present invention is to provide a rotor of a rotating electric machine that achieves both an increase in maximum torque and a reduction in stress, and further reduces torque ripple.

### Solution to Problem

A rotor of a rotating electric machine including a pair of magnets arranged in a V shape and a rotor core provided with magnet holes into which the magnets are inserted, in which the rotor core has, on an outside in a radial direction, a magnetic gap between the rotor core and an outermost diameter corner located on an outermost side in the radial direction among corners of the magnet, and has a protrusion formed so as to protrude toward the magnet between a first outermost diameter portion closer to a magnetic pole center of the rotor than the outermost diameter corner in an outer diameter of the magnetic gap and a second outermost diameter portion closer to a magnetic pole boundary of the rotor than the outermost diameter corner in an outermost diameter of the magnetic gap, and the protrusion faces a main surface of the magnet.

### Advantageous Effects of Invention

It is possible to provide a rotor of a rotating electric machine that achieves both an increase in maximum torque and a reduction in stress, and further reduces torque ripple.

### BRIEF DESCRIPTION OF DRAWINGS

FIG. 1 is a cross-sectional view of a rotating electric machine.

FIG. 2 is a partially enlarged view of a rotor core according to an embodiment of the present invention.

FIG. 3 illustrates an example of a part of a rotor core according to a conventional technique.

FIGS. 4A and 4B are graphs illustrating an effect of an embodiment of the present invention.

FIG. 5 is a view of a distance between an outer peripheral surface and a magnetic gap according to an embodiment of the present invention.

### ONE EMBODIMENT AND OVERALL CONFIGURATION OF THE PRESENT INVENTION

Hereinafter, embodiments of the present invention will be described with reference to the drawings. The following description and drawings are examples for describing the present invention, and are omitted and simplified as appropriate for the sake of clarity of description. The present invention can be carried out in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the position, size, shape, range, and the like disclosed in the drawings.

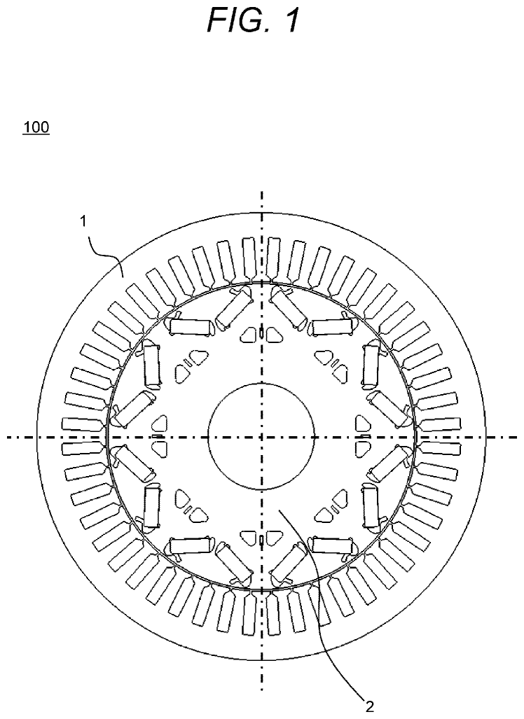

### (FIG. 1)

The rotating electric machine 100 includes a stator 1 and a rotor 2. The rotor 2 faces the stator 1 via a predetermined air gap (gap). The rotating electric machine 100 is, for example, a permanent magnet rotating electric machine used for driving a vehicle.

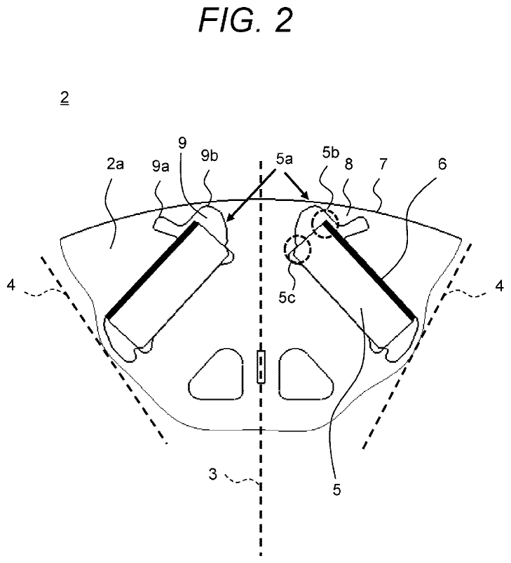

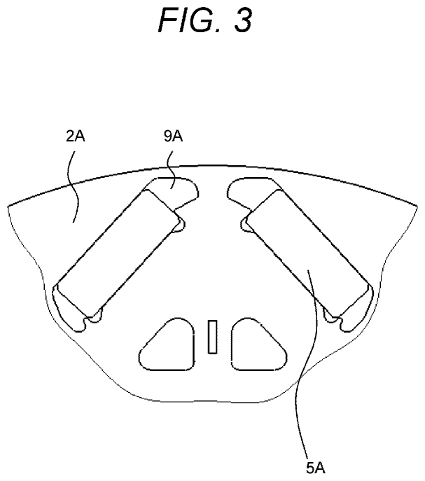

### (FIGS. 2 and 3)

The rotor 2 includes a pair of magnets 5 arranged in a V shape, and a rotor core 2a provided with magnet holes 5a into which the magnets 5 are inserted. When the magnet 5 is inserted into the magnet hole 5a, a magnetic gap 9 is formed on the outside in a radial direction. The magnetic gap 9 is a gap for reducing the leakage magnetic flux of the magnet 5, and is provided between the outermost diameter portion of the rotor core 2a and the outermost diameter corner 5b located on the outermost side in the radial direction among the corner portions of the magnet 5.

In the outermost diameter portion of the magnetic gap 9, a portion close to a magnetic pole center 4 of the rotor 2 is defined as a first outermost diameter portion 9a. In the outermost diameter portion of the magnetic gap 9, a portion close to a magnetic pole boundary 3 of the rotor 2 is defined as a second outermost diameter portion 9b.

Although not illustrated in FIG. 2, the other magnet 5 is formed in the rotor core 2a across the magnetic pole center 4, and one magnetic pole is formed by such a pair of magnets 5. In the rotor core 2a, N poles and S poles are alternately arranged. The magnetic pole center 4 and the magnetic pole boundary 3 are a d-axis which is a center of portions to be the N pole and the S pole and is a direction of a magnetic flux formed by the magnetic pole, and a q-axis which is electrically and magnetically orthogonal to the d-axis, respectively.

A side between the first outermost diameter portion 9a and the second outermost diameter portion 9b is provided with a protrusion 8 formed radially inward (on the central axis side of the rotor core 2a) and protruding toward the magnet 5. The protrusion 8 faces a main surface 6 of the magnet 5 with a predetermined gap interposed therebetween. The main surface 6 is a surface to be a magnetic pole (N pole, S pole) of the rotor 2.

In FIG. 3 which is a conventional technique, a magnetic gap 9A provided by a magnet 5A inserted into the magnet hole of the rotor core 2A does not have a structure like the above-described protrusion 8. If the protrusion 8 is not provided as in the conventional technique, the path of the magnetic flux becomes narrow as a whole, and the magnetic flux density becomes high, so that the maximum torque increases but the torque ripple increases.

In order to solve this problem, in the present invention, by providing the protrusion 8, the passage of the magnetic flux in the outermost diameter portion of the rotor core 2a is partially widened, so that the magnetic flux density is reduced to reduce the torque, and by partially narrowing the first outermost diameter portion 9a and the second outermost diameter portion 9b, the torque is increased to control the level of each magnetic flux density at the rotational position. As a result, the maximum torque of the rotating electric machine 100 is increased as compared with the conventional shape, and the torque ripple for each current phase is further reduced.

In addition, the predetermined gap between the protrusion 8 and the main surface 6 of the magnet has an effect on stress. If this predetermined gap is filled, the area of the protrusion 8 increases and becomes heavy, and the maximum value of the stress of the portion supporting the protrusion 8 increases. In addition, if the support portion is thickened in order to reduce the stress, the leakage magnetic flux increases, and the maximum torque decreases. Therefore, by providing a predetermined gap between the protrusion 8 and the main surface 6 of the magnet, both suppression of an increase in the maximum stress value and suppression of a decrease in the maximum torque are achieved.

In order to enhance the fixability of the magnet 5 inserted in the magnet hole 5a, a corner 5c closest to the magnetic pole boundary 3 among the corners of the magnet 5 is in contact with the rotor core 2a.

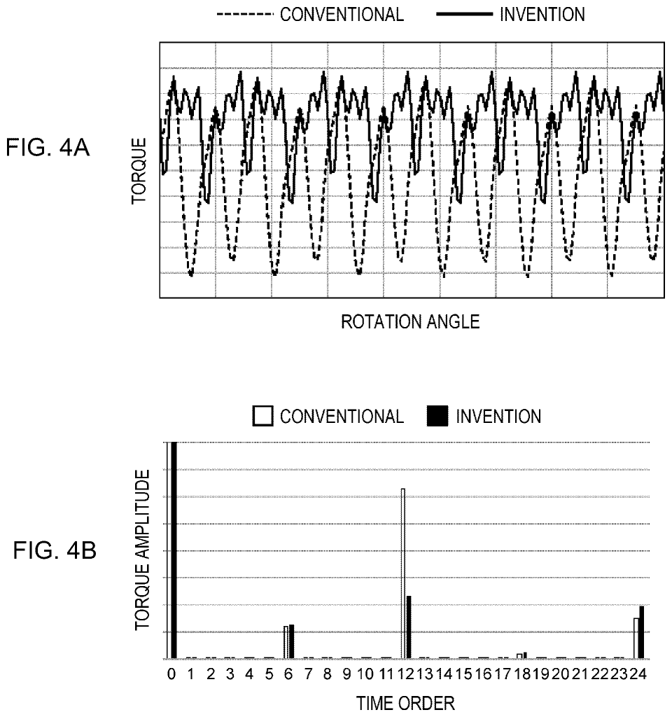

### (FIGS. 4A and 4B)

FIG. 4A illustrates a difference in torque ripple between the configuration of the conventional technique (see FIG. 3) and the configuration of the present invention (see FIG. 2). In the configuration of the conventional technique indicated by the dotted line, the degree of a variation amount (torque ripple) of the torque of the rotating electric machine is large. However, in the configuration of the present invention indicated by the solid line, it can be seen that the torque ripple is reduced as compared with the conventional technique indicated by the dotted line.

FIG. 4B is a comparison of changes in torque ripple for each time order between the configuration of the conventional technique and the configuration of the present invention. In general, in the three-phase AC motor, the torque ripple is generated in the harmonic component of a multiple of 6 with respect to the fundamental wave. However, in the present invention, the torque ripple in the time order of 12 can be reduced by 60% as compared with the configuration of the conventional technique.

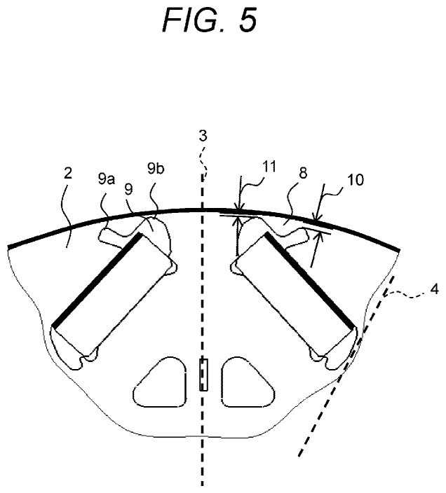

### (FIG. 5)

In each of the first outermost diameter portion 9a and the second outermost diameter portion 9b illustrated in FIG. 2, the magnetic path (the outermost diameter portion of the magnetic gap 9) is narrowed as compared with the protrusion 8, so that the magnetic flux density is increased and the torque is increased. The first outermost diameter portion 9a and the second outermost diameter portion 9b are formed such that a distance 10 and a distance 11 are different from each other from the outer peripheral surface of the rotor core 2a to the magnetic gap 9.

This is because, according to the experimental results, it has been found that when the distance 10 and the distance 11 are the same, the strength increases and the maximum value of the stress can be reduced, but the leakage magnetic flux increases as the path of the magnetic flux increases, and the maximum torque decreases. As illustrated in FIG. 5, by making a difference in the gap portion with the distance 11<the distance 10, it is possible to achieve both an increase in the maximum torque and a reduction in the maximum value of the stress.

According to the embodiment of the present invention described above, the following operational effects are obtained.

(1) The rotor 2 of the rotating electric machine 100 includes a pair of magnets 5 arranged in a V shape, and a rotor core 2a provided with magnet holes 5a into which the magnets 5 are inserted. The rotor core 2a has, on the outside in a radial direction, a magnetic gap 9 between the rotor core 2a and the outermost diameter corner 5b located on the outermost side in the radial direction among the corners of the magnet 5, and has a protrusion 8 formed so as to protrude toward the magnet 5 between a first outermost diameter portion 9a closer to the magnetic pole center 4 of the rotor 2 than the outermost diameter corner 5b in the outer diameter of the magnetic gap 9 and a second outermost diameter portion 9b closer to the magnetic pole boundary 3 of the rotor 2 than the outermost diameter corner 5b in the outermost diameter of the magnetic gap 9. The protrusion 8 faces the main surface 6 of the magnet 5. With this configuration, it is possible to provide the rotor 2 of the rotating electric machine 100 that achieves both an increase in maximum torque and a reduction in stress, and further reduces the torque ripple.

(2) The protrusion 8 faces the main surface 6 of the magnet 5 with a predetermined gap interposed therebetween. In this way, the stress on the rotor 2 can be reduced.

(3) The distance between the outer peripheral surface of the rotor 2 and the first outermost diameter portion 9a is longer than the distance between the outer peripheral surface of the rotor 2 and the second outermost diameter portion 9b. With this configuration, it is possible to achieve both an increase in the maximum torque of the rotating electric machine 100 and a reduction in the maximum value of the stress.

(4) Among the corners of the magnet 5, the corner 5c closest to the magnetic pole boundary 4 is in contact with the rotor core 2a. With such a configuration, the fixing property of the magnet 5 to the rotor core 2a is enhanced.

(5) The rotating electric machine 100 includes the rotor 2 illustrated in one embodiment of the present invention, and a stator 1 facing the rotor 2 with a predetermined air gap interposed therebetween. With this configuration, it is possible to achieve the rotating electric machine 100 that achieves both an increase in maximum torque and a reduction in stress, and further reduces the torque ripple.

Note that the present invention is not limited to the above embodiments, and various modifications and other configurations can be combined without departing from the gist of the present invention. In addition, the present invention is not limited to one including all the configurations described in the above embodiment, and includes one in which a part of the configuration is deleted.

### REFERENCE SIGNS LIST

1 stator
2 rotor
2a rotor core
3 magnetic pole boundary
4 magnetic pole center
5 magnet
5a magnet hole
5b outermost diameter corner
5c corner on magnetic pole boundary side
6 main surface of magnet
7 outer peripheral surface
8 protrusion
9 magnetic gap
9a first outermost diameter portion
9b second outermost diameter portion
10 distance between outer peripheral surface and magnetic gap (first outermost diameter portion)
11 distance between outer peripheral surface and magnetic gap (second outermost diameter portion)
100 rotating electric machine

1. A rotor of a rotating electric machine comprising: a pair of magnets arranged in a V shape; and a rotor core provided with magnet holes into which the magnets are inserted, wherein
the rotor core has, on an outside in a radial direction, a magnetic gap between the rotor core and an outermost diameter corner located on an outermost side in the radial direction among corners of the magnet, and has a protrusion formed so as to protrude toward the magnet between a first outermost diameter portion closer to a magnetic pole center of the rotor than the outermost diameter corner in an outer diameter of the magnetic gap and a second outermost diameter portion closer to a magnetic pole boundary of the rotor than the outermost diameter corner in an outermost diameter of the magnetic gap, and
the protrusion faces a main surface of the magnet.

2. The rotor of a rotating electric machine according to claim 1, wherein the protrusion faces a main surface of the magnet with a predetermined gap interposed therebetween.

3. The rotor of a rotating electric machine according to claim 1, wherein a distance between an outer peripheral surface of the rotor and the first outermost diameter portion is longer than a distance between an outer peripheral surface of the rotor and the second outermost diameter portion.

4. The rotor of a rotating electric machine according to claim 1, wherein among corners of the magnet, a corner closest to the magnetic pole boundary is in contact with the rotor core.

5. A rotating electric machine comprising:
the rotor of the rotating electric machine according to claim 1; and
a stator facing the rotor with a predetermined air gap interposed therebetween.

6. A rotating electric machine comprising:
the rotor of the rotating electric machine according to claim 2; and
a stator facing the rotor with a predetermined air gap interposed therebetween.

7. A rotating electric machine comprising:
the rotor of the rotating electric machine according to claim 3; and
a stator facing the rotor with a predetermined air gap interposed therebetween.

8. A rotating electric machine comprising:
the rotor of the rotating electric machine according to claim 4; and
a stator facing the rotor with a predetermined air gap interposed therebetween.
